(19) United States
(12) Patent Application Publication
(10) Pub. No.: US 2025/0373729 A1
(43) Pub. Date: Dec. 4, 2025

(54) SYSTEMS AND METHODS FOR CALLBACK MANAGEMENT

(71) Applicant: FMR LLC, Boston, MA (US)

(72) Inventors: Prateek Nayak, Gujarat (IN); Giri Venkataramanan, Chennai (IN)

(21) Appl. No.: 18/731,946

(22) Filed: Jun. 3, 2024

(51) Int. Cl. H04M 3/523

(52) U.S. Cl. CPC H04M 3/5231; H04M 3/5233

(57) ABSTRACT

A computerized method is provided for managing automated customer callbacks in a call center. Systems and methods can include machine-learning analysis of call-wrap patterns to identify speech patterns and/or words or phrases indicative that a call is about to end. Methods can use this information to more precisely que a next customer callback in order to minimize customer and agent wait times while increasing satisfaction and efficiency.

### TECHNICAL FIELD

This application relates generally to systems, methods and apparatuses, including computer program products, for customer callback management.

### BACKGROUND

Contact Center Callback is a feature of IVR (interactive voice response) systems that allows a caller to choose to be called back rather than wait on hold in the phone queue. Most callback dialing strategies fall into one of two categories, agent-first or customer-first depending on which party it places on the line first. Agent-first provides a better customer experience because the agent is secured on the line first and the customer does not have to wait to be connected. However, that method is less efficient for agents and requires them to be on the line while the next customer is contacted, even if that customer does not pick up the call. In contrast, the customer-first category ensures a good agent experience but can negatively impact customer satisfaction as they may be stuck waiting while an agent becomes available, especially where the agent's prior call goes longer than anticipated. Unfortunately, at present most callback systems are limited to one or the other strategy and hence can focus only on agent or customer experience while sacrificing the other. The customer-first strategy is most efficient (i.e., cost effective) for companies as it limits employee downtime and is therefore commonly used. Such systems automatically contact the customer and ensure they are on the line before presenting the caller to an agent. That approach provides the greatest level of contact center efficiency by eliminating the need to reserve the agents first and then initiate calls to the customers.

Recent advancements have attempted to improve the customer experience in customer-first callback dialing strategies by, for example, using an average call handling time to predict when an agent may become available and queuing the next customer at that predicted time. However, these methods do not provide any guarantee that an agent will be available at the predicted time and cannot anticipate large ranges in call times such as might be experienced in a call center servicing a variety of customer issues.

### SUMMARY

Systems and methods of the present disclosure address the aforementioned problems associated with existing callback dialing strategies and provides better equilibrium between agent satisfaction and efficiency and customer experience. Callback systems disclosed herein can address those problems by initiating a callback to customers based on machine-learning analysis of call wrap patterns to better predict when an agent will be ending one call and becoming available for the next call.

Calls can be recorded and, through machine learning analysis of the end of those calls, an algorithm can be trained to identify indicators linked to a call about to end. Those indicators can be specific words or combinations of words used by the customer and/or the agent and can even include changes in speech volume, tone, or other characteristics alone or in combination with the words themselves. Once a database of call-wrap patterns is built, all calls can be continuously analyzed to identify any of those call-wrap patterns which can then trigger the system to prepare the next call for that agent by, for example, identifying the next queued customer whose needs can be addressed by the agent and initiating a call back to that customer. The callback system can also take into account timing of agent requirements or breaks between calls in order to properly time the callback.

Aspects of the invention can include a computerized method for managing customer callbacks with steps including storing, in a non-transitory memory in communication with a processor a callback schedule database of pending callbacks, each pending callback comprising a callback number, customer information, calling intent, a required agent skill, and a scheduled callback time and timestamp; an agent database of available agents, each available agent entry comprising an agent identifier and an agent skill; and a call wrap pattern database comprising a plurality of speech patterns indicative of a call ending. Methods can include monitoring, by the processor, a customer call between a first customer and an agent, to identify a preset call wrap pattern from the call wrap pattern database. Upon identifying the preset call wrap pattern, methods can include searching, by the processor, the callback schedule database for a pending callback having the scheduled callback timestamp lesser than the current timestamp in the database; comparing, by the processor, the required agent skill for the pending callback having the scheduled callback timestamp lesser than the current timestamp with the agent skill of the agent on the monitored customer call to determine agent suitability for the pending callback; and when the agent on the monitored customer call is determined suitable for the pending callback having the scheduled callback timestamp lesser than the current timestamp, automatically initiating an outgoing call to the callback number of the pending callback having the scheduled callback timestamp lesser than the current timestamp.

In certain embodiments, methods can include analyzing a plurality of customer calls using a machine learning algorithm, to identify a call wrap pattern and adding the call wrap pattern to the call wrap pattern database as a preset call wrap pattern. Analyzing the plurality of customer calls can consist of analyzing a selected portion of the plurality of customer calls before each of the plurality of customer calls was ended by a respective customer. The selected portion may consist of 30 seconds or less. In some embodiments, the preset call wrap pattern can include one or more of, a word from the first customer, a word from the agent, a pattern of words from the customer, a pattern of words from the agent, a pattern of words between the customer and agent, a voice attribute of the customer, and a voice attribute of the agent.

The voice attribute of the customer or the voice attribute of the agent can include one or more of speed, volume, timbre, tone, or changes therein. In some embodiments, methods can include, when the agent on the monitored customer call is determined not suitable for the pending callback having the scheduled callback timestamp lesser than the current timestamp, selecting the next pending callback having the scheduled callback timestamp lesser than the current timestamp from the list of scheduled callbacks and repeating the comparing step. The outgoing call may be initiated before the customer call between the first customer and the agent has ended. The outgoing call can be initiated at a selected interval after the preset call wrap pattern is identified. The call wrap pattern database can include an estimated time to call end for each call wrap pattern, wherein the selected interval is based on the estimated time to call end for the identified preset call wrap pattern.

Upon initiating the outgoing call, methods can include waiting for an answer and automatically placing the answered call into a queue for the agent on the monitored customer call. Monitoring the customer call can include generating a transcript of the customer call in real time and comparing each word or phrase in the transcript against each speech pattern in the call wrap pattern database.

In certain aspects, systems of the invention can include a computer system for managing customer callbacks, with the system comprising a computing device comprising a processor and a memory storing: a callback schedule database of pending callbacks, each pending callback comprising a callback number, customer information, calling intent, a required agent skill, and a scheduled callback time and timestamp; an agent database of available agents, each available agent entry comprising an agent identifier and an agent skill; a call wrap pattern database comprising a plurality of speech patterns indicative of a call ending. The memory can further store instructions that, when executed by the processor, cause the processor to perform the steps of monitoring a customer call between a first customer and an agent, to identify in the customer call a preset call wrap pattern from the call wrap pattern database. Upon identifying the preset call wrap pattern, the processor can search the callback schedule database for a pending callback having the scheduled callback timestamp lesser than the current timestamp in the database; compare the required agent skill for the pending callback having the scheduled callback timestamp lesser than the current timestamp with the agent skill of the agent on the monitored customer call to determine agent suitability for the pending callback; and when the agent on the monitored customer call is determined suitable for the pending callback having the scheduled callback timestamp lesser than the current timestamp, automatically initiate an outgoing call to the callback number of the pending callback having the scheduled callback timestamp lesser than the current timestamp. In various embodiments systems of the invention can be operable to perform any and all of the aforementioned methods.

### BRIEF DESCRIPTION OF THE DRAWINGS

The advantages of the invention described above, together with further advantages, may be better understood by referring to the following description taken in conjunction with the accompanying drawings. The drawings are not necessarily to scale, emphasis instead generally being placed upon illustrating the principles of the invention.

FIG. 1 is a block diagram of a system for managing customer callbacks.

FIG. 2 shows an exemplary method for managing customer callbacks.

FIG. 3 shows an exemplary flow chart for a computerized method of managing customer callbacks.

FIG. 4 shows an exemplary callback database entry.

FIG. 5 shows exemplary call wrap pattern database entries.

FIG. 6 shows an exemplary skills database entry.

FIG. 7 shows exemplary call recording storage.

FIG. 8 shows exemplary real time call transcripts and callback function logs.

FIG. 9 illustrates an exemplary user interface for agents.

### DETAILED DESCRIPTION

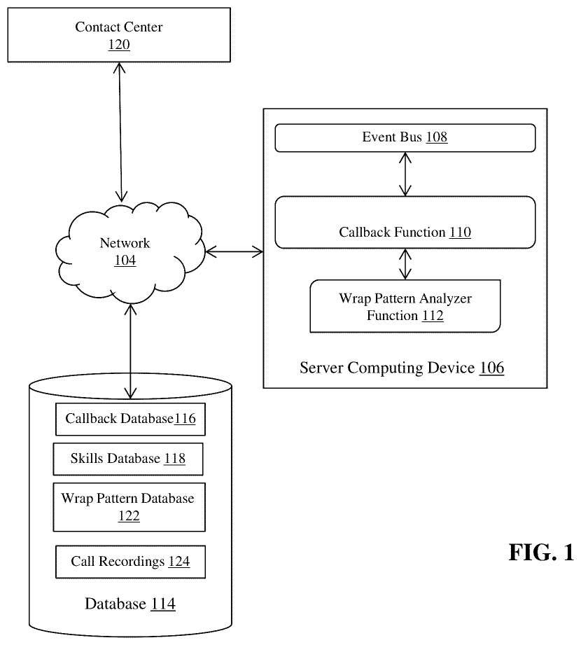

FIG. 1 is a block diagram of a system 100 for automatic monitoring and cataloging of messages. The system 100 includes a communications network 104; a server computing device 106 that includes an event bus 108, a callback function 110 and a call wrap pattern analyzer function 112; a database 114 that includes callback data 116 and agent skills data 118, call wrap pattern data 122, and call recordings 124; and a contact center platform 120.

The contact center 120 connects to one or more communications networks (e.g., network 104) in order to communicate with the server computing device 106 to provide input and receive output relating to ongoing and upcoming customer calls. The agent may interact with the contact center 120 using a computing device including but not limited to server computing devices, desktop computers, laptop computers, tablets, mobile devices, smartphones, and the like. Typically, the computing device includes a display device that is embedded in and/or coupled to the client computing device for the purpose of displaying information to a user of the device. It should be appreciated that other types of computing devices that are capable of connecting to the components of the system 100 can be used without departing from the scope of invention. It should be appreciated that the system 100 can include any number of computing devices used by a variety of agents, administrators, supervisors, and other parties.

In some embodiments, the computing device(s) can execute one or more software applications that are used to provide input to and receive output from the contact center application 120 and/or the server computing device 106. For example, the computing device can be configured to execute one or more native applications and/or one or more browser applications. Generally, a native application is a software application (in some cases, called an ‘app’) that is installed locally on the computing device and written with programmatic code designed to interact with an operating system that is native to the computing device. Such software may be available from, e.g., the Apple® App Store, the Google® Play Store, the Microsoft® Store, or other software download platforms depending upon, e.g., the type of device used. In some embodiments, the native application includes a software development kit (SDK) module that is executed by a processor of the computing device to perform functions associated with customer service calls and otherwise communicate with the contact center 120. Generally, a browser application comprises software executing on a processor of the computing device that enables the client computing device to communicate via HTTP or HTTPS with remote servers addressable with URLs (e.g., server computing device 106) to receive website-related content, including one or more webpages, for rendering in the browser application and presentation on the display device coupled to the computing device. Exemplary mobile browser application software includes, but is not limited to, Firefox™, Chrome™, Safari™, and other similar software. The one or more webpages can comprise visual and audio content for display to and interaction with a user.

The communications network 104 enables the computing device and/or the contact center application 120 to communicate with the server computing device 106. The network 104 is typically comprised of one or more wide area networks, such as the Internet and/or a cellular network, and/or local area networks. In some embodiments, the network 104 is comprised of several discrete networks and/or sub-networks (e.g., cellular to Internet).

The server computing device 106 is a device including specialized hardware and/or software modules that execute on a processor and interact with memory modules of the server computing device 106, to receive data from other components of the system 100, transmit data to other components of the system 100, and perform functions for managing customer callbacks for the contact center 120. The server computing device 106 includes an event bus 108, a callback function 110, and a call wrap pattern analyzer function 112 that execute on the processor of the server computing device 106. In some embodiments, the modules 108, 110, and 112 are specialized sets of computer software instructions programmed onto one or more dedicated processors in the server computing device 106 and can include specifically designated memory locations and/or registers for executing the specialized computer software instructions.

Although the computing modules 108, 110, and 112 are shown in FIG. 1 as executing within the same server computing device 106, in some embodiments the functionality of the computing modules 108, 110, and 112 can be distributed among a plurality of server computing devices or may be performed in so-called “serverless” environments such as AWS Lambda (Amazon Web Services, Seattle, Washington). As shown in FIG. 1, the server computing device 106 enables the computing modules 108, 110, and 112 to communicate with each other and the database 114 in order to exchange data for the purpose of performing the described functions. It should be appreciated that any number of computing devices, arranged in a variety of architectures, resources, and configurations (e.g., cluster computing, virtual computing, cloud computing) can be used without departing from the scope of the invention. The exemplary functionality of the computing modules 108, 110, and 112 is described in detail throughout this specification.

The database 114 is a computing device (or in some embodiments, a set of computing devices) coupled to the server computing device 106 (in some embodiments, via communications network 104) and is configured to receive, generate, and store specific segments of data relating to the process of customer callback management for the contact center 120. In some embodiments, all or a portion of the database 114 can be integrated with the server computing device 106 or be located on a separate computing device or devices. The database 114 can comprise one or more databases configured to store portions of data used by the other components of the system 100, as will be described in greater detail below.

In some embodiments, the database 114 comprises callback data 116, agent skills data 118, call wrap pattern data 122, and call recordings 124. Generally, the callback data 116 comprises data related to pending callbacks including customer information, inquiry topics, and/or required agent skills for responding to the customer inquiry.

Generally, the skills data 118 comprises the skills for each of the available agents indicating what types of calls or customer issues, each available agent can handle. This skills data 118 can include Boolean information (yes/no for each skill for each agent) or may include a proficiency rating (e.g., a 1 to 5 scale or percentage proficiency for each skill).

The call wrap pattern data 122 can include various call wrap patterns identified by the system as indicative of a customer call ending soon. For some or all of the possible call wrap patterns, the call wrap pattern data 122 can further include a predicted call duration after the observed wrap pattern, a probability of the call ending within a certain amount of time after observing the wrap pattern, and/or the effect on such timing information of various combinations of wrap patterns being observed in a call along with other information gleaned through machine-learning analysis of prior customer calls.

Call recording data 124 can include complete recordings of customer calls to be used as a training set for the machine learning algorithm identifying call wrap patterns. The recording data 124 can include entire customer calls or may include only a portion of such calls (e.g., the last 10 seconds, 30 seconds, minute, or more of calls).

The contact center platform 120 comprises one or more computing devices (such as server computing devices) that are coupled to the server computing device 106 in order to manage incoming customer calls, customer callbacks, and call center agents. The platform 120 can provide an interface for agents to interact with customer calls and can provide call information to the server computing device 106 and database 114 and initiate customer callbacks while accepting callback triggers or other information from the callback function 110. The contact center platform 120 can include commercially available third-party software or services such as Amazon Connect (Amazon Web Services, Seattle, Washington).

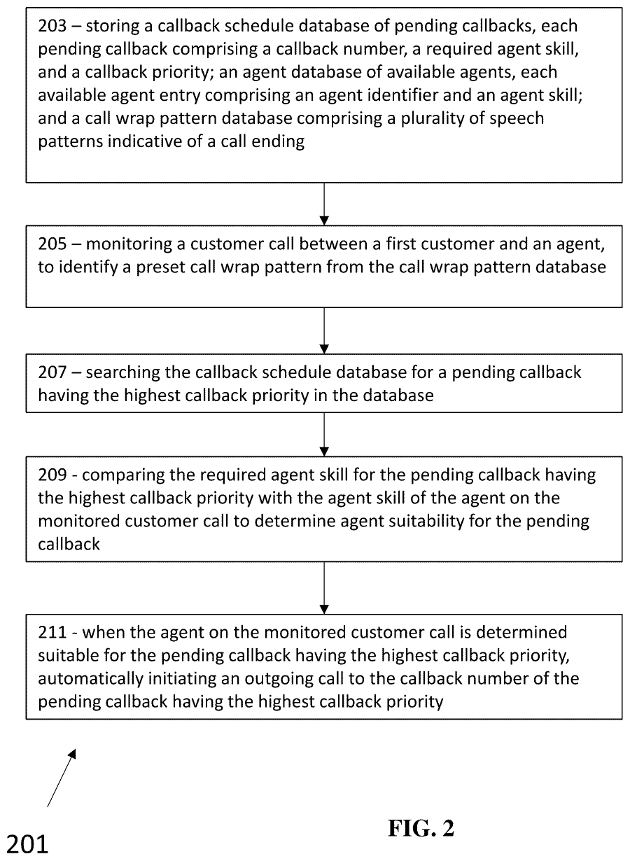

FIG. 2 shows an exemplary method 201 for customer callback management. A callback schedule database of pending callbacks is stored 203 with each pending callback comprising a callback number, customer information, calling intent, a required agent skill, and a scheduled callback time and timestamp. An agent database of available agents and a call wrap pattern database are also stored 203 with each available agent entry comprising an agent identifier and an agent skill and the call wrap pattern database comprising a plurality of speech patterns indicative of a call ending.

The processor is used to monitor 205 a customer call between a first customer and an agent, to identify a preset call wrap pattern from the call wrap pattern database. The processor can then be used to search 207 the callback schedule database for a pending callback having the scheduled callback timestamp lesser than the current timestamp and/or a highest callback priority which may be assigned based on waiting time, client information, client call subject, or some combination thereof in the database.

Methods can then include comparing 209 the required agent skill for the pending callback having the scheduled callback timestamp lesser than the current timestamp with the agent skill of the agent on the monitored customer call to determine agent suitability for the pending callback. When the agent on the monitored call is determined suitable for the pending callback having the scheduled callback timestamp lesser than the current timestamp, methods can include automatically initiating 211 an outgoing call to the callback number of the pending callback having the scheduled callback timestamp lesser than the current timestamp.

In certain embodiments, call recordings can be cataloged and used as a training set in a machine learning algorithm to identify call wrap patterns that are indicative of a call ending. Exemplary machine learning algorithms that can be used to identify call wrap patterns using call recordings can include, but are not limited to, logistic regression, random forest, deep neural network, xgboost classifier, multilayer perceptron and deep learning models. The machine learning algorithm(s) can be provided with customer call recordings generally or, preferably. customer call recordings from the specific industry in which the call center will be operating. Even more preferably, the customer call recordings are from the specific company for which the call center operates. This is because, while some call wrap patterns may be universal (e.g., the customer saying goodbye), others may be industry or even company-specific (e.g., the use of industry jargon or terms or a company-mandated closing phrase).

The machine learning algorithm is provided with the call recordings in which to identify common patterns across multiple calls that are linked to the outcome of the call ending. Accordingly, the call recordings can be limited to the end of calls such as the last 2 minutes, 1 minute, 30 seconds, or other interval in order to reduce storage requirements and focus the analysis. As the call center operates, new calls can be continuously saved into the call recordings database and be provided to for analysis in order to update and improve the model and identify new call wrap patterns. The machine learning algorithms can be provided with audio recordings of calls and/or transcripts of calls.

The algorithms can consider any number of call characteristics in identifying a call wrap pattern including a word from the customer, a word from the agent, a pattern of words from the customer, a pattern of words from the agent, a pattern of words, conversation, or exchange between the customer and agent, a voice attribute of the customer, or a voice attribute of the agent. Voice attributes can include, for example, speed, volume, timbre, tone, or changes therein. An advantage of machine learning algorithms is the ability to independently identify patterns in data not recognizable to the human eye or ear and, in some instances, existing in a category that a human may not have even foreseen. For example, in the case of providing audio data, the machine learning algorithm can be agnostic to the meaning of the words being said and might analyze speech waveforms and changes therein to identify heretofore unknown indicators of a call ending. In various embodiments, call wrap patterns can include words, phrases, and/or speech characteristics alone, or in combination wherein certain combinations observed within certain timeframes may be more indicative of a call ending than any of the indicators observed alone.

For each call wrap pattern identified, the algorithm can provide an approximate time from observation of the pattern until the call is anticipated to end. As part of that timing information. the database can include a confidence indicator or other information relative to the prediction. As each call wrap pattern is identified, it can be added to the call wrap pattern database as a preset call wrap pattern.

When a call wrap pattern has been identified, if the agent on the monitored customer call is determined not suitable for the pending callback having the scheduled callback timestamp lesser than the current timestamp, the callback function can proceed with selecting the next pending callback having the scheduled callback timestamp lesser than the current timestamp from the list of scheduled callbacks until a suitable match in skill sets and required skills is found. Outgoing calls can be initiated before the customer call between the first customer and the agent has ended or at some selected interval after the preset call wrap pattern is identified. For example, agents may require a fixed period for note taking, summary, data entry, or break after each call or number of calls. Systems and methods of the invention can take such periods into account and time the callback based thereon.

When the outgoing call is initiated, systems and methods of the invention can include waiting for an answer and automatically placing the answered call into a queue for the agent on the monitored customer call.

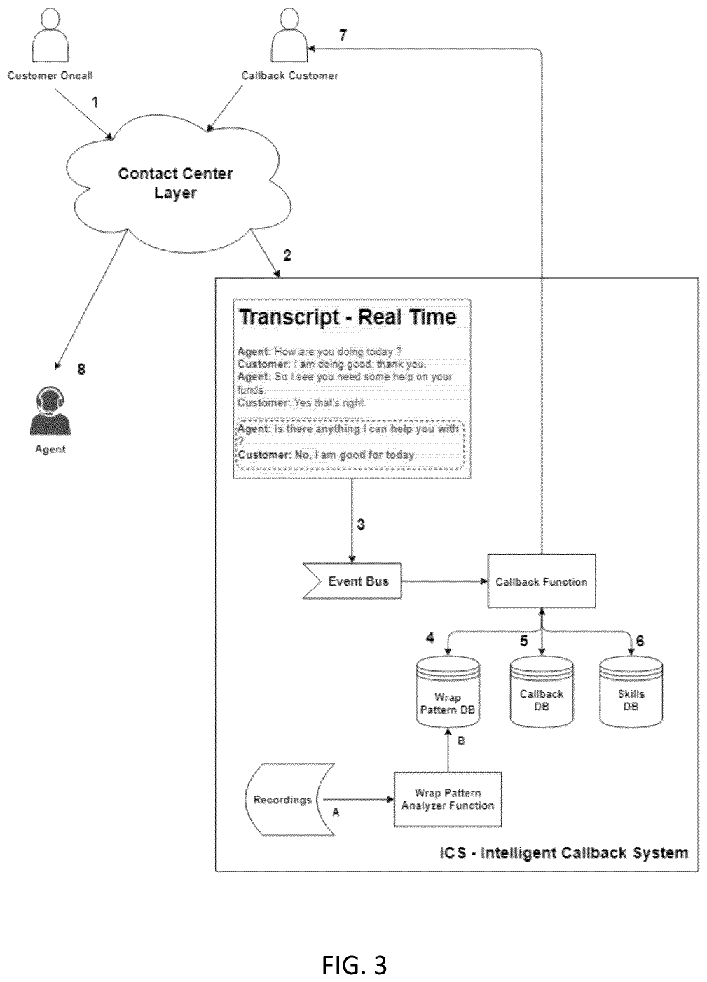

FIG. 3 shows an exemplary flow chart for a computerized method of managing customer callbacks. As depicted, a customer is already on call with the agent. A transcript of the conversation happening between agent and customer is being generated by the contact center and provided to the callback system. For every utterance, an event bus gets triggered which invokes the callback function. The callback function matches the utterance against known wrap patterns in a wrap pattern database to find out if the agent's utterance is one of the wrap patterns or not. If the utterance is one of the wrap patterns, the callback function checks if there any scheduled callback to be triggered. The callback function also checks whether the agent possess the skill required to handle the callback or not. Assuming the agent does possess the required skill, the callback function triggers the call to the customer and puts them in the queue. The customer then gets connected to the agent as soon as the agent winds up their previous call. Call recordings are stored in a storage device B. The wrap pattern analyzer function analyzes the last 10 seconds of each call and stores those patterns in the wrap pattern DB. The functions can be serverless functions and the databases can be NoSQL databases with the wrap pattern DB storing the call wrap patterns; the callback DB storing the callback details which can include customer's information like name, phone number, time of callback and other relevant information; and the skills DB storing the mapping between the agent skill required for each calling intent.

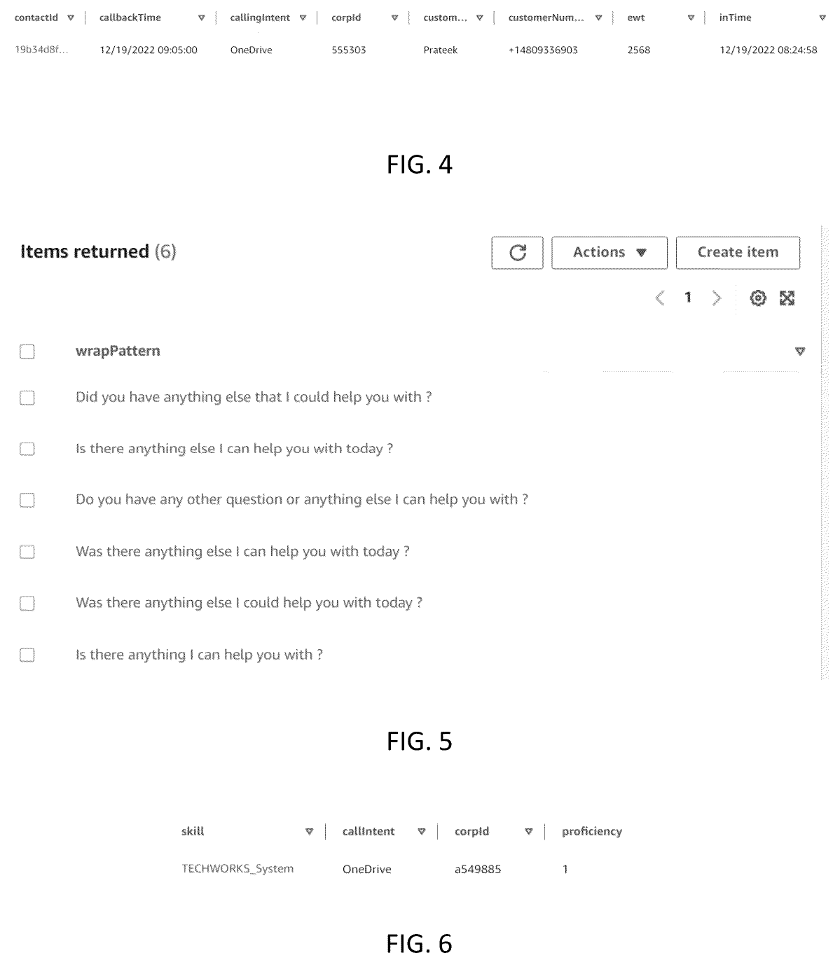

FIG. 4 shows an exemplary callback database entry. The entry includes, for example, a unique identifier for that queued callback, a callback time, a call intent, a customer name, a customer telephone number for the callback, and an original call time. The call intent is indicative of what the customer's needs are and can be used to determine the required agent skills for handling the callback.

FIG. 5 shows exemplary call wrap pattern database entries. In the illustrated example, the entries are text based, determined from call transcripts but one of skill in the art will recognize that the same principles can be applied to audio or other data that can be analyzed for unique patterns indicative of calls ending. The call wrap pattern database illustrated in FIG. 5 includes agent utterances such as “Is there anything I can help you with?” that have been linked to call endings. The call wrap pattern database can be automatically populated by the machine learning algorithm(s) processing call recording data and/or may be manually edited as well (e.g., using the “create item” button on the database interface).

FIG. 6 shows an exemplary skills database entry. For a given agent (for example identified in the corpld column) a proficiency score is noted for a certain skill that is associated with a call intent. The proficiency score can be simple (e.g., 1 for possessing the skill and 0 for not possessing the skill) or nuanced (e.g., a scaled system indicating varying levels of proficiency for each skill). Where a proficiency range is provided, a threshold proficiency can be specified by a user or administrator for any or all skills in order to qualify for handling callbacks for various call intents.

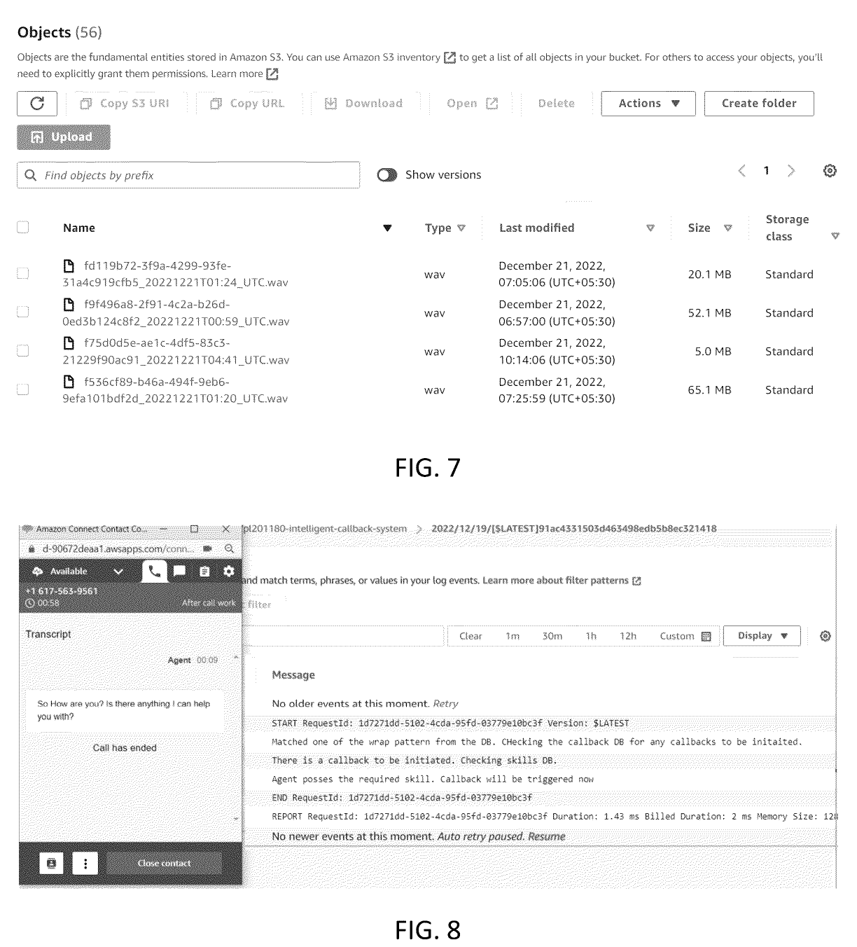

FIG. 7 shows exemplary call recording storage. As noted, the call storage can be continuously updated and used by the machine learning algorithm(s) to improve call wrap predictions. The call records can be automatically stored or manually uploaded. As shown in FIG. 7, a user interface can be provided for manipulation of the call recordings.

FIG. 8 shows exemplary real time call transcripts and callback function logs. As noted, the callback function has been triggered by the event bus by an agent uttering “So how are you? Is there anything I can help you with?” The callback function has mapped one of the phrases (“Is there anything I can help you with?”) to a known wrap pattern in the wrap pattern database and determined that a callback should be initiated for the next call in the queue. The callback function has checked the queued callback requirements and compared to the agent's skills and, finding a suitable match, has triggered a callback.

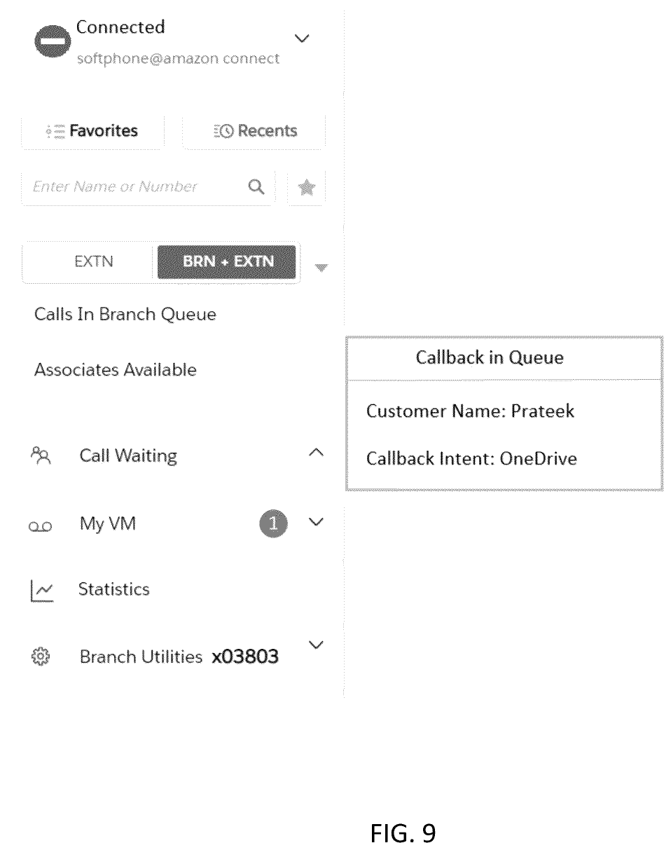

FIG. 9 illustrates an exemplary user interface for agents providing information on their current call and the queued callback waiting for them. That information includes the customer's name as well as the intended topic so the agent can prepare for the call.

The above-described techniques can be implemented in digital and/or analog electronic circuitry, or in computer hardware, firmware, software, or in combinations of them. The implementation can be as a computer program product, i.e., a computer program tangibly embodied in a machine-readable storage device, for execution by, or to control the operation of, a data processing apparatus, e.g., a programmable processor, a computer, and/or multiple computers. A computer program can be written in any form of computer or programming language, including source code, compiled code, interpreted code and/or machine code, and the computer program can be deployed in any form, including as a stand-alone program or as a subroutine, element, or other unit suitable for use in a computing environment. A computer program can be deployed to be executed on one computer or on multiple computers at one or more sites. The computer program can be deployed in a cloud computing environment (e.g., Amazon® AWS, Microsoft® Azure, IBM®).

Method steps can be performed by one or more processors executing a computer program to perform functions of the invention by operating on input data and/or generating output data. Method steps can also be performed by, and an apparatus can be implemented as, special purpose logic circuitry, e.g., a FPGA (field programmable gate array), a FPAA (field-programmable analog array), a CPLD (complex programmable logic device), a PSoC (Programmable System-on-Chip), ASIP (application-specific instruction-set processor), or an ASIC (application-specific integrated circuit), or the like. Subroutines can refer to portions of the stored computer program and/or the processor, and/or the special circuitry that implement one or more functions.

Processors suitable for the execution of a computer program include, by way of example, special purpose microprocessors specifically programmed with instructions executable to perform the methods described herein, and any one or more processors of any kind of digital or analog computer. Generally, a processor receives instructions and data from a read-only memory or a random access memory or both. The essential elements of a computer are a processor for executing instructions and one or more memory devices for storing instructions and/or data. Memory devices, such as a cache, can be used to temporarily store data. Memory devices can also be used for long-term data storage. Generally, a computer also includes, or is operatively coupled to receive data from or transfer data to, or both, one or more mass storage devices for storing data, e.g., magnetic, magneto-optical disks, or optical disks. A computer can also be operatively coupled to a communications network in order to receive instructions and/or data from the network and/or to transfer instructions and/or data to the network. Computer-readable storage mediums suitable for embodying computer program instructions and data include all forms of volatile and non-volatile memory, including by way of example semiconductor memory devices, e.g., DRAM, SRAM, EPROM, EEPROM, and flash memory devices; magnetic disks, e.g., internal hard disks or removable disks; magneto-optical disks; and optical disks, e.g., CD, DVD, HD-DVD, and Blu-ray disks. The processor and the memory can be supplemented by and/or incorporated in special purpose logic circuitry.

To provide for interaction with a user, the above described techniques can be implemented on a computing device in communication with a display device, e.g., a CRT (cathode ray tube), plasma, or LCD (liquid crystal display) monitor, a mobile computing device display or screen, a holographic device and/or projector, for displaying information to the user and a keyboard and a pointing device, e.g., a mouse, a trackball, a touchpad, or a motion sensor, by which the user can provide input to the computer (e.g., interact with a user interface element). Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, and/or tactile input.

The above-described techniques can be implemented in a distributed computing system that includes a back-end component. The back-end component can, for example, be a data server, a middleware component, and/or an application server. The above described techniques can be implemented in a distributed computing system that includes a front-end component. The front-end component can, for example, be a client computer having a graphical user interface, a Web browser through which a user can interact with an example implementation, and/or other graphical user interfaces for a transmitting device. The above described techniques can be implemented in a distributed computing system that includes any combination of such back-end, middleware, or front-end components.

The components of the computing system can be interconnected by transmission medium, which can include any form or medium of digital or analog data communication (e.g., a communication network). Transmission medium can include one or more packet-based networks and/or one or more circuit-based networks in any configuration. Packet-based networks can include, for example, the Internet, a carrier internet protocol (IP) network (e.g., local area network (LAN), wide area network (WAN), campus area network (CAN), metropolitan area network (MAN), home area network (HAN)), a private IP network, an IP private branch exchange (IPBX), a wireless network (e.g., radio access network (RAN), Bluetooth, near field communications (NFC) network, Wi-Fi, WiMAX, general packet radio service (GPRS) network, HiperLAN), and/or other packet-based networks. Circuit-based networks can include, for example, the public switched telephone network (PSTN), a legacy private branch exchange (PBX), a wireless network (e.g., RAN, code-division multiple access (CDMA) network, time division multiple access (TDMA) network, global system for mobile communications (GSM) network), and/or other circuit-based networks.

Information transfer over transmission medium can be based on one or more communication protocols. Communication protocols can include, for example, Ethernet protocol, Internet Protocol (IP), Voice over IP (VOIP), a Peer-to-Peer (P2P) protocol, Hypertext Transfer Protocol (HTTP), Session Initiation Protocol (SIP), H.323, Media Gateway Control Protocol (MGCP), Signaling System #7 (SS7), a Global System for Mobile Communications (GSM) protocol, a Push-to-Talk (PTT) protocol, a PTT over Cellular (POC) protocol, Universal Mobile Telecommunications System (UMTS), 3GPP Long Term Evolution (LTE) and/or other communication protocols.

Devices of the computing system can include, for example, a computer, a computer with a browser device, a telephone, an IP phone, a mobile computing device (e.g., cellular phone, personal digital assistant (PDA) device, smart phone, tablet, laptop computer, electronic mail device), and/or other communication devices. The browser device includes, for example, a computer (e.g., desktop computer and/or laptop computer) with a World Wide Web browser (e.g., Chrome™ from Google, Inc., Microsoft® Internet Explorer® available from Microsoft Corporation, and/or Mozilla® Firefox available from Mozilla Corporation). Mobile computing device include, for example, a Blackberry® from Research in Motion, an iPhone® from Apple Corporation, and/or an Android™-based device. IP phones include, for example, a Cisco® Unified IP Phone 7985G and/or a Cisco® Unified Wireless Phone 7920 available from Cisco Systems, Inc.

Comprise, include, and/or plural forms of each are open ended and include the listed parts and can include additional parts that are not listed. And/or is open ended and includes one or more of the listed parts and combinations of the listed parts.

One skilled in the art will realize the subject matter may be embodied in other specific forms without departing from the spirit or essential characteristics thereof. The foregoing embodiments are therefore to be considered in all respects illustrative rather than limiting of the subject matter described herein.

What is claimed is:

1. A computerized method for managing customer callbacks, the method comprising:
storing, in a non-transitory memory in communication with a processor:
a callback schedule database of pending callbacks, each pending callback comprising a callback number, customer information, calling intent, a required agent skill, and a scheduled callback time and timestamp;
an agent database of available agents, each available agent entry comprising an agent identifier and an agent skill; and
a call wrap pattern database comprising a plurality of speech patterns indicative of a call ending;
monitoring, by the processor, a customer call between a first customer and an agent, to identify a preset call wrap pattern from the call wrap pattern database;
upon identifying the preset call wrap pattern:
searching, by the processor, the callback schedule database for a pending callback having a scheduled callback time earlier than a current timestamp in the database;
comparing, by the processor, the required agent skill for the pending callback having the scheduled callback time earlier than the current timestamp with the agent skill of the agent on the monitored customer call to determine agent suitability for the pending callback; and
when the agent on the monitored customer call is determined suitable for the pending callback having the scheduled callback time earlier than the current timestamp, automatically initiating an outgoing call to the callback number of the pending callback having the scheduled callback time earlier than the current timestamp.

2. The computerized method of claim 1, further comprising analyzing a plurality of customer calls using a machine learning algorithm, to identify a call wrap pattern and adding the call wrap pattern to the call wrap pattern database as a preset call wrap pattern.

3. The computerized method of claim 2, wherein analyzing the plurality of customer calls consists of analyzing a selected portion of the plurality of customer calls before each of the plurality of customer calls was ended by a respective customer.

4. The computerized method of claim 3, wherein the selected portion consists of 30 seconds or less.

5. The computerized method of claim 1, wherein the preset call wrap pattern comprises one or more of, a word from the first customer, a word from the agent, a pattern of words from the customer, a pattern of words from the agent, a pattern of words between the customer and agent, a voice attribute of the customer, and a voice attribute of the agent.

6. The computerized method of claim 5, wherein the voice attribute of the customer or the voice attribute of the agent comprises one or more of speed, volume, timbre, tone, or changes therein.

7. The method of claim 1, further comprising,
when the agent on the monitored customer call is determined not suitable for the pending callback having the scheduled callback time earlier than the current timestamp, selecting the next pending callback having the scheduled callback time earlier than the current timestamp from callback schedule and repeating the comparing step.

8. The method of claim 1, wherein the outgoing call is initiated before the customer call between the first customer and the agent has ended.

9. The method of claim 1, wherein the outgoing call is initiated at a selected interval after the preset call wrap pattern is identified.

10. The method of claim 9, wherein the call wrap pattern database comprises an estimated time to call end for each call wrap pattern, wherein the selected interval is based on the estimated time to call end for the identified preset call wrap pattern.

11. The method of claim 1, further comprising, upon initiated the outgoing call, waiting for an answer and automatically placing the answered call into a que for the agent on the monitored customer call.

12. The method of claim 1, wherein monitoring the customer call comprises generating a transcript of the customer call in real time and comparing each word or phrase in the transcript against each speech pattern in the call wrap pattern database.

13. A computer system for managing customer callbacks, the system comprising a computing device comprising a processor and a memory storing:
a callback schedule database of pending callbacks, each pending callback comprising a callback number, customer information, calling intent, a required agent skill, a scheduled callback time, and a timestamp;
an agent database of available agents, each available agent entry comprising an agent identifier and an agent skill;
a call wrap pattern database comprising a plurality of speech patterns indicative of a call ending; and
instructions that, when executed by the processor, cause the processor to perform the steps of:
monitoring a customer call between a first customer and an agent, to identify in the customer call a preset call wrap pattern from the call wrap pattern database; and
upon identifying the preset call wrap pattern:
searching the callback schedule database for a pending callback having a scheduled callback time earlier than a current timestamp in the database in the database;
comparing the required agent skill for the pending callback having the scheduled callback time earlier than the current timestamp in the database with the agent skill of the agent on the monitored customer call to determine agent suitability for the pending callback; and
when the agent on the monitored customer call is determined suitable for the pending callback having the scheduled callback time earlier than the current timestamp, automatically initiating an outgoing call to the callback number of the pending callback having the scheduled callback time earlier than the current timestamp.

14. The computer system of claim 13, the processor further operable to analyze a plurality of customer calls using a machine learning algorithm, to identify a call wrap pattern and adding the call wrap pattern to the call wrap pattern database as a preset call wrap pattern.

15. The computer system of claim 14, wherein analyzing the plurality of customer calls consists of analyzing a selected portion of the plurality of customer calls before each of the plurality of customer calls was ended by a respective customer.

16. The computer system of claim 15, wherein the selected portion consists of 30 seconds or less.

17. The computer system of claim 13, wherein the preset call wrap pattern comprises one or more of, a word from the first customer, a word from the agent, a pattern of words from the customer, a pattern of words from the agent, a pattern of words between the customer and agent, a voice attribute of the customer, and a voice attribute of the agent.

18. The computer system of claim 17, wherein the voice attribute of the customer or the voice attribute of the agent comprises one or more of speed, volume, timbre, tone, or changes therein.

19. The computer system of claim 13, wherein the processor if further operable to, when the agent on the monitored customer call is determined not suitable for the pending callback having the scheduled callback time earlier than the current timestamp, select a pending callback having the scheduled callback time earlier than the current timestamp from the callback schedule and repeating the comparing step.

20. The computer system of claim 13, wherein the outgoing call is initiated before the customer call between the first customer and the agent has ended.
